(19) United States
(12) Patent Application Publication
(10) Pub. No.: US 2021/0272528 A1
(43) Pub. Date: Sep. 2, 2021

(54) DISPLAY DEVICE

(71) Applicant: SHARP KABUSHIKI KAISHA, Sakai City, Osaka (JP)

(72) Inventors: NAOKO GOTO, Sakai City, Osaka (JP); AYA OKAMOTO, Sakai City, Osaka (JP)

(21) Appl. No.: 17/256,608

(22) PCT Filed: Jul. 9, 2019
(86) PCT No.: PCT/JP2019/027188

§ 371 Date: Dec. 28, 2020

(30) Foreign Application Priority Data
Jul. 12, 2018 (JP) 2018-132526

(51) Int. Cl. G09G 3/34; G02F 1/13357

(52) U.S. Cl. CPC G09G 3/3426; G09G 2320/0626; G09G 2360/16; G02F 1/133603

(57) ABSTRACT

Provided is a display device capable of controlling, for each of a plurality of drive areas having different shapes, a plurality of light-emitting elements included in a backlight, or capable of controlling, for each of a plurality of drive areas having different numbers of light-emitting elements, a plurality of light-emitting elements included in the backlight. A second light-source emission-intensity calculating unit included in an area-active driving unit calculates a second emission intensity of each light-emitting element. The brightness distribution of each pixel of a display panel is calculated from the second emission intensity of each light-emitting element.

### TECHNICAL FIELD

The present disclosure relates to a display device that includes a display panel and a backlight.

### BACKGROUND ART

Recent typical display devices, such as liquid-crystal displays, perform display using local dimming (also called area activation), thus offering high image quality and low power consumption.

FIG. 7 illustrates a backlight 103 included in a conventional display device and being a target for area-active drive.

FIG. 7(a) illustrates the backlight 103 that undergoes area-active drive. The backlight 103 includes a plurality of light-emitting elements 114. It is common that the entire backlight 103 is divided into a plurality of drive areas A, B, C, D, E, F . . . , each of which includes a plurality of light-emitting elements 114; in FIG. 7(a), each area includes four light-emitting elements 114. That is, the drive areas A, B, C, D, E, F . . . respectively include groups of light-emitting elements 113A, 113B, 113C, 113D, 113E, 113F . . . each having a plurality of light-emitting elements 114; in FIG. 7(a), each group includes four light-emitting elements 114.

FIG. 7(b) illustrates, by way of example, driving the group of light-emitting elements 113A, which belongs to the drive area A of the backlight 103 shown in FIG. 7(a) and includes four light-emitting elements 114. As illustrated in the drawing, the four light-emitting elements 114 in the group of light-emitting elements 113A are connected to one channel of a backlight drive circuit 101. The four light-emitting elements 114 in the group of light-emitting elements 113A constitute one unit of drive that is driven by the backlight drive circuit 101 using a current value or pulse-width-modulation (PWM) value based on the emission intensity of the drive area A. Although not shown, the groups of light-emitting elements 113B, 113C, 113D, 113E, 113F . . . , which respectively belong to the other drive areas B, C, D, E, F . . . and individually include four light-emitting elements 114, each also constitute one unit of drive that is driven by the backlight drive circuit 101 using a current value or PWM value based on the emission intensity of each of the drive areas B, C, D, E, F . . . .

FIG. 7(c) illustrates a point spread function (PSF) that is a profile of light in one drive area, and is used in common for the conventional display device to calculate a brightness distribution for each pixel of its display panel corresponding to each of all the drive areas A, B, C, D, E, F . . . .

The conventional display device calculates the brightness distribution of each pixel of the display panel on the basis of the emission intensity of each of the drive areas A, B, C, D, E, F . . . . When calculating the brightness distribution of each pixel of the display panel, the device uses the common PSF in one drive area shown in FIG. 7(c).

### CITATION LIST

### Patent Literature

Patent Literature 1: Japanese Patent Application Laid-Open No. 2009-192963 (published on Aug. 27, 2009)

### SUMMARY OF INVENTION

### Technical Problem

However, the conventional display device in FIG. 7 uses the common PSF in one drive area shown in FIG. 7(c) to calculate the brightness distribution of each pixel of the display panel on the basis of the emission intensity of each of the drive areas A, B, C, D, E, F . . . . The conventional display device hence requires the drive areas A, B, C, D, E, F . . . to have the same shape and to have the same number of light-emitting elements 114.

That is, whereas the light-emitting elements in the backlight are controlled for each of the drive areas A, B, C, D, E, F . . . , the conventional display device requires all the drive areas A, B, C, D, E, F . . . to have the same shape and to have the same number of light-emitting elements. Unfortunately, this device is thus used under such limited conditions.

To solve this problem, it is an object of the present disclosure to provide a display device capable of controlling, for each of a plurality of drive areas having different shapes, a plurality of light-emitting elements included in its backlight, or capable of controlling, for each of a plurality of drive areas having different numbers of light-emitting elements, a plurality of light-emitting elements included in the backlight.

### Solution to Problem

To solve the above problem, a display device in the present disclosure includes the following: an area-active drive circuit, a backlight including a plurality of light-emitting elements that are controlled for each of a plurality of drive areas in accordance with a first signal from the area-active drive circuit; and a display panel that performs display in accordance with a second signal from the area-active drive circuit. The area-active drive circuit includes a first light-source emission-intensity calculation circuit that calculates a first emission intensity of each of the plurality of light-emitting elements in accordance with received image data. The area-active drive circuit also includes a drive-area emission-intensity calculation circuit that calculates one emission intensity for each of the plurality of drive areas in accordance with the first emission intensity of each of the plurality of light-emitting elements and in accordance with area information about which of the plurality of drive areas each of the plurality of light-emitting elements belongs to. The drive-area emission-intensity calculation circuit outputs the one emission intensity as the first signal. The area-active drive circuit also includes a second light-source emission-intensity calculation circuit that calculates a second emission intensity of each of the plurality of light-emitting elements in accordance with the one emission intensity in each of the plurality of drive areas. The area-active drive circuit also includes an image-data correction circuit that corrects a gradation value of the received image data in accordance with the brightness distribution of a pixel of the display panel. The brightness distribution is calculated from the second emission intensity of each of the plurality of light-emitting elements. The image-data correction circuit outputs the gradation value after correction as the second signal.

### Advantageous Effect of Invention

This configuration offers a display device capable of controlling, for each of a plurality of drive areas having different shapes, a plurality of light-emitting elements included in its backlight, or capable of controlling, for each of a plurality of drive areas having different numbers of light-emitting elements, a plurality of light-emitting elements included in the backlight.

### BRIEF DESCRIPTION OF DRAWINGS

FIG. 1 illustrates a display device according to a first embodiment.

FIG. 2(a) illustrates part of a backlight included in the display device in FIG. 1 and being a target for area-active drive. FIG. 2(b) illustrates, by way of example, driving a group of light-emitting elements belonging to a drive area A and having four light-emitting elements. FIG. 2(c) illustrates, by way of example, calculating the emission intensity of the drive area A. FIG. 2(d) illustrates a point spread function (PSF) of one light-emitting element that is used in common in the display device shown in FIG. 1.

FIG. 3(a) illustrates calculating second emission intensities of a plurality of light-emitting elements in the drive area A by using the average value of first emission intensities of the light-emitting elements in the drive area A. FIG. 3(b) illustrates calculating the second emission intensities of the light-emitting elements in the drive area A by using the maximum value of the first emission intensities of the light-emitting elements in the drive area A.

FIG. 4 illustrates part of a backlight includable in a display device according to a second embodiment and being a target for area-active drive.

FIG. 5 illustrates part of other backlights includable in the display device according to the second embodiment and being a target for area-active drive.

FIG. 6 illustrates part of a backlight includable in a display device according to a third embodiment and being a target for area-active drive.

FIG. 7 illustrates a backlight included in a conventional display device and being a target for area-active drive.

### DESCRIPTION OF EMBODIMENTS

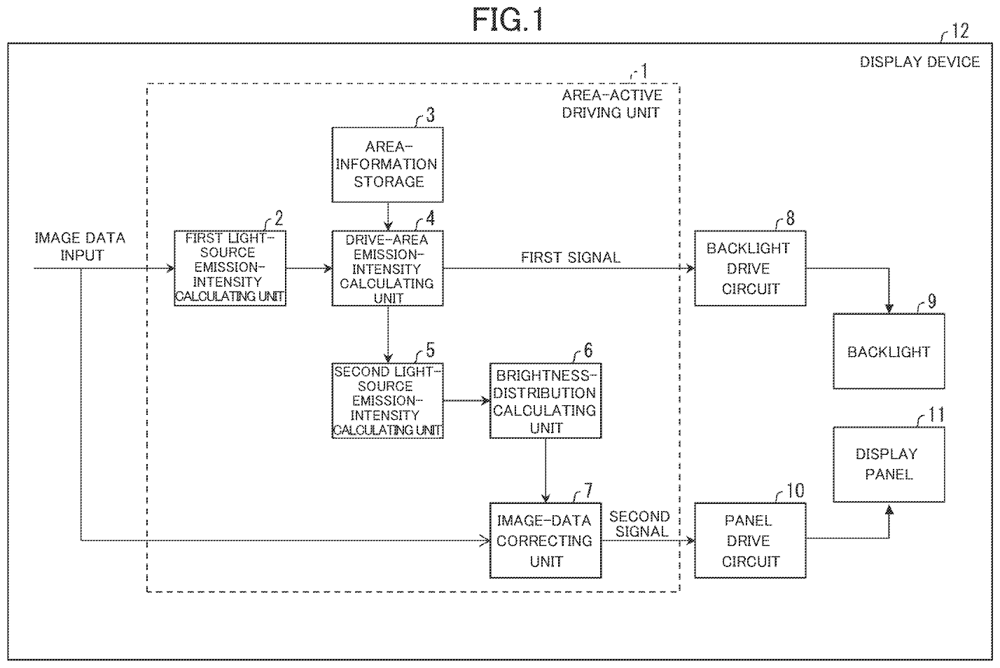

Embodiments of the present disclosure will be described with reference to FIGS. 1 to 6. For convenience in description, components having the same functions as those described in particular embodiments will be denoted by the same signs and will not be elaborated upon.

### First Embodiment

With reference to FIGS. 1 to 3, the following describes a display device 12 according to a first embodiment.

FIG. 1 illustrates the display device 12 that uses area activation to perform display.

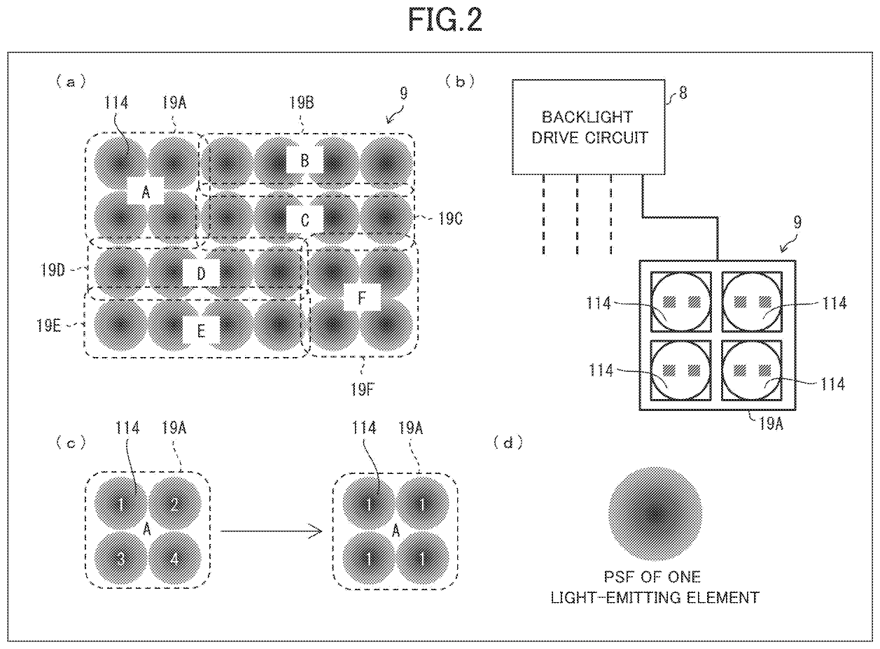

FIG. 2(a) illustrates part of a backlight 9 included in the display device 12 in FIG. 1 and being a target for area-active drive. FIG. 2(b) illustrates, by way of example, driving a group of light-emitting elements 19A belonging to a drive area A and including four light-emitting elements 114. FIG. 2(c) illustrates, by way of example, calculating a second emission intensity of the drive area A. FIG. 2(d) illustrates a point spread function (PSF) of one light-emitting element that is used in common in the display device 12 shown in FIG. 1.

The display device 12 includes an area-active driving unit 1 (area-active drive circuit), a backlight drive circuit 8, the backlight 9, a panel drive circuit 10, and a display panel 11, as illustrated in FIG. 1. The area-active driving unit 1 includes a first light-source emission-intensity calculating unit 2 (first light-source emission-intensity calculation circuit), an area-information storage 3, a drive-area emission-intensity calculating unit 4 (drive-area emission-intensity calculation circuit), a second light-source emission-intensity calculating unit 5 (second light-source emission-intensity calculation circuit), a brightness-distribution calculating unit 6 (brightness-distribution calculation circuit), and an image-data correcting unit 7 (image-data correction circuit).

The backlight 9 includes a plurality of light-emitting elements 114, as illustrated in FIG. 2(a). The entire backlight 9 is divided into a plurality of drive areas A, B, C, D, E, F . . . , each of which includes a plurality of light-emitting elements 114; in FIG. 2(a), each area includes four light-emitting elements 114. That is, the drive areas A, B, C, D, E, F . . . respectively include groups of light-emitting elements 19A, 19B, 19C, 19D, 19E, 19F . . . each including a plurality of light-emitting elements 114; in FIG. 2(a), each group includes four light-emitting elements 114. As illustrated in FIG. 1, the light-emitting elements 114 in the backlight 9 are controlled for each of the drive areas A, B, C, D, E, F . . . by the backlight drive circuit 8 using a first signal from the area-active driving unit 1.

As illustrated in FIG. 2(b), the four light-emitting elements 114 in the group of light-emitting elements 19A of the backlight 9 are connected to one channel of the backlight drive circuit 8. The four light-emitting elements 114 in the group of light-emitting elements 19A constitute one unit of drive that is driven by the backlight drive circuit 8 using a current value or pulse-width-modulation (PWM) value. Although not shown, the groups of light-emitting elements 19B, 19C, 19D, 19E, 19F . . . , which respectively belong to the other drive areas B, C, D, E, F . . . and individually include four light-emitting elements 114, are also connected to respective different channels of the backlight drive circuit 8, and each constitute one unit of drive that is driven by the backlight drive circuit 8 using a current value or PWM value.

As illustrated in FIG. 1, the display panel 11 that performs display is driven by the panel drive circuit 10 using a second signal from the area-active driving unit 1.

The first light-source emission-intensity calculating unit 2 calculates the first emission intensity of each light-emitting element 114 of the backlight 9 in accordance with received image data.

The area-information storage 3 stores area information about which of the drive areas A, B, C, D, E, F . . . each light-emitting element 114 of the backlight 9 belongs to. This embodiment describes, by way of example, providing the area-information storage 3 separately. In some cases, the area information may be stored in the first light-source emission-intensity calculating unit 2 or the drive-area emission-intensity calculating unit 4, and in these cases, the area-information storage 3 does not have to be provided separately.

The drive-area emission-intensity calculating unit 4 calculates one emission intensity for each of the drive areas A, B, C, D, E, F . . . on the basis of the first emission intensity of each light-emitting element 114 and on the basis of the area information. The drive-area emission-intensity calculating unit 4 then outputs, to the backlight drive circuit 8, the emission intensity as the first signal.

The following describes, by way of example, how to calculate one emission intensity for each of the drive areas A, B, C, D, E, F . . . . Reference is made to the first emission intensities of the four light-emitting elements 114 in the group of light-emitting elements 19A, which belongs to the drive area A. As illustrated in FIG. 2(c), let the light-emitting element 114 on the upper left of the drawing have the largest intensity (denoted by a numeral 1), let the light-emitting element 114 on the upper right of the drawing have the second largest intensity (denoted by a numeral 2), let the light-emitting element 114 on the lower left of the drawing have the third largest intensity (denoted by a numeral 3), and let the light-emitting element 114 on the lower right of the drawing have the smallest intensity (denoted by a numeral 4). Accordingly, the first emission intensity of the light-emitting element 114 on the upper left, which is the largest of the emission intensities of the four light-emitting elements 114, can be defined as one emission intensity in the drive area A. Moreover, although not shown, the average value of the emission intensities of the four light-emitting elements 114 can be also defined as one emission intensity in the drive area A.

The second light-source emission-intensity calculating unit 5 calculates the second emission intensity of each light-emitting element 114 in accordance with one emission intensity in each of the drive areas A, B, C, D, E, F . . . . Herein, the second emission intensity is a value of the emission intensity of each light-emitting element 114 obtained by developing one emission intensity in each of the drive areas A, B, C, D, E, F . . . into the individual emission intensities of the corresponding light-emitting elements 114. The second light-source emission-intensity calculating unit 5 then outputs, to the brightness-distribution calculating unit 6, the calculated second emission intensity of each light-emitting element 114 in each of the drive areas A, B, C, D, E, F . . . .

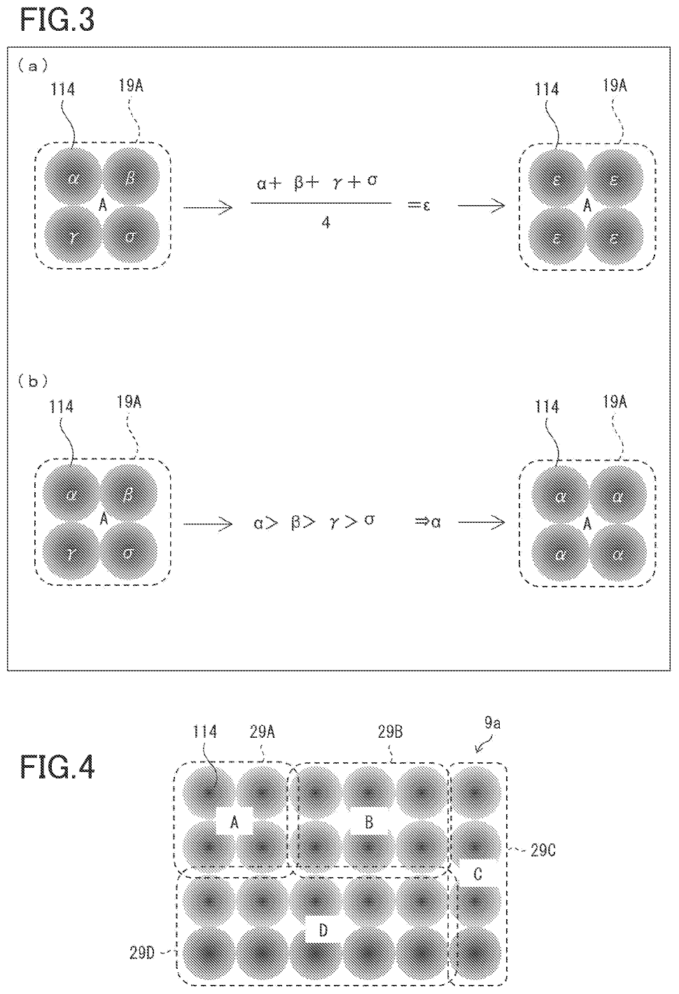

With reference to FIG. 3, the following describes, by way of example, how to calculate one emission intensity for each of the drive areas A, B, C, D, E, F . . . in accordance with the first emission intensity of each light-emitting element 114 and in accordance with the area information. The following also describes, by way of example, how to develop the one emission intensity into the individual emission intensities of the corresponding light-emitting elements 114 in each of the drive areas A, B, C, D, E, F . . . to obtain the second emission intensity.

FIG. 3(a) illustrates calculating the second emission intensity of the group of light-emitting elements 19A, which belongs to the drive area A and includes four light-emitting elements 114, by using the average value of the first emission intensities of the four light-emitting elements 114 in the group of light-emitting elements 19A, which belongs to the drive area A and includes four light-emitting elements 114. FIG. 3(b) illustrates calculating the second emission intensity of the group of light-emitting elements 19A, which belongs to the drive area A and includes four light-emitting elements 114, by using the maximum value of the first emission intensities of the four light-emitting elements 114 in the group of light-emitting elements 19A, which belongs to the drive area A and includes four light-emitting elements 114.

Let the first emission intensities of the light-emitting elements 114 in the drive area A be expressed as α, β, γ, and δ, as illustrated in FIG. 3(a). In addition, let the average value of the first emission intensities of the light-emitting elements 114 in the drive area A, calculated by the drive-area emission-intensity calculating unit 4, be expressed as ε. The average value a can be defined as one emission intensity in the drive area A. The average value ε then undergoes development into the individual emission intensities of the light-emitting elements 114 corresponding to the drive area A. This can obtain a second emission intensity E.

Let the first emission intensities of the light-emitting elements 114 in the drive area A be expressed as α>β>γ>δ, as illustrated in FIG. 3(b). In this case, the drive-area emission-intensity calculating unit 4 may calculate the maximum value of the first emission intensities of the light-emitting elements 114 included in the drive area A. This maximum value a can be accordingly defined as one emission intensity in the drive area A. The maximum value a then undergoes development into the individual emission intensities of the light-emitting elements 114 corresponding to the drive area A. This can obtain a second emission intensity α.

This embodiment has described, by way of example, using the maximum value or average value of the first emission intensities of the light-emitting elements 114 in each of the drive areas A, B, C, D, E, F . . . . In some embodiment, how to calculate one emission intensity may be different from each other between the drive areas A, B, C, D, E, F . . . ; for instance, one emission intensity in the drive area A may be calculated using the average value of the first emission intensities of the light-emitting elements 114 in the drive area A, and one emission intensity in the drive area B may be calculated using the maximum value of the first emission intensities of the light-emitting elements 114 in the drive area B.

The brightness-distribution calculating unit 6 calculates the brightness distribution of each pixel of the display panel 11, from the second emission intensity of each light-emitting element 114. The brightness-distribution calculating unit 6 uses a common point spread function (PSF) of one light-emitting element as shown in FIG. 2(d) to calculate the spread of light (brightness distribution) in each pixel of the display panel 11. This embodiment describes, by way of example, providing the brightness-distribution calculating unit 6 separately. In some embodiments, the brightness distribution may be calculated by, for instance, the image-data correcting unit 7.

The image-data correcting unit 7 corrects the gradation value of the received image data in accordance with the brightness distribution of each pixel of the display panel 11, calculated from the second emission intensity of each light-emitting element 114. The image-data correcting unit 7 then outputs, to the panel drive circuit 10, the gradation value after correction as the second signal.

It is noted that each light-emitting element 114 may be, for instance, a white light-emitting element consisting of integrated LED elements that emit a plurality of different colors of light, such as an LED element that emits white light, an LED element that emits red light, an LED element that emits green light, and an LED that emits blue light.

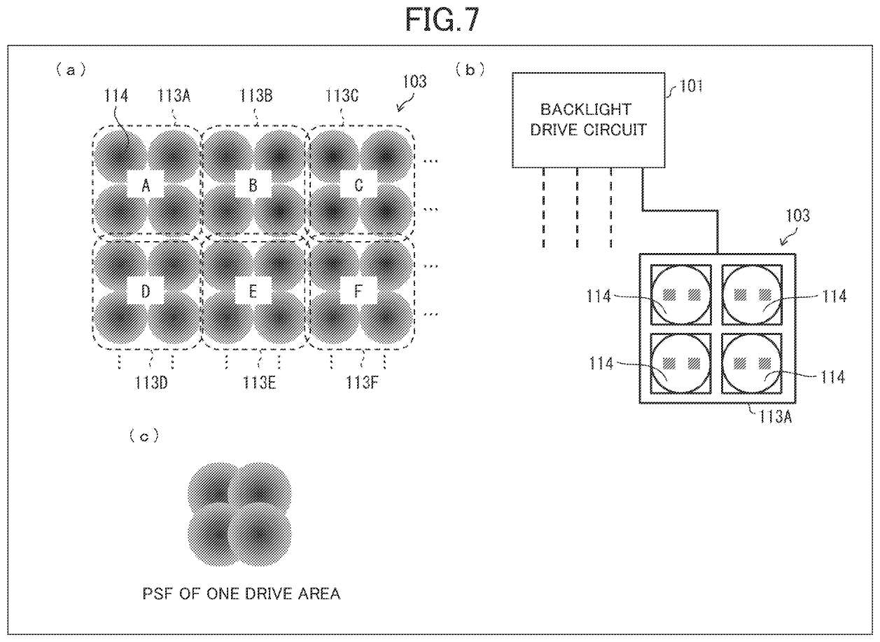

A conventional display device calculates, using a common PSF of one drive area, the brightness distribution of each pixel of its display panel in accordance with the emission intensity in each of the drive areas A, B, C, D, E, F . . . (see FIG. 7). The conventional display device requires all the drive areas A, B, C, D, E, F . . . to have the same shape and to have the same number of light-emitting elements. Unfortunately, this device is thus used under such limited conditions.

In contrast, the display device 12 includes the second light-source emission-intensity calculating unit 5 that, as described above, calculates the second emission intensity of each light-emitting element 114. The display device 12 calculates, from the second emission intensity of each light-emitting element 114, the brightness distribution of each pixel of the display panel 11. The display device also calculates the spread of light (brightness distribution) in each pixel of the display panel 11 by using a common point spread function (PSF) of one light-emitting element as shown in FIG. 2(d).

The drive areas A, B, C, D, E, F . . . of the backlight 9 in the display device 12 can thus include two kinds of drive area different from each other in shape, as illustrated in FIG. 2(a).

This embodiment has described, by way of example, that the drive areas A, B, C, D, E, F . . . of the backlight 9 in the display device 12 include two kinds of drive area different from each other in shape. In some embodiment, the drive areas A, B, C, D, E, F . . . of the backlight 9 in the display device 12 may include three or more kinds of drive area, that is, a plurality of kinds of drive area, different from each other in shape. Alternatively, the drive areas A, B, C, D, E, F . . . of the backlight 9 in the display device 12 may include a plurality of kinds of drive area having different numbers of light-emitting elements 114 from each other. The details will be described in second and third embodiments. Alternatively, in combination with these alternatives, the drive areas A, B, C, D, E, F . . . of the backlight 9 in the display device 12 may include a plurality of kinds of drive area different from each other in shape and having different numbers of light-emitting elements 114 from each other.

### Second Embodiment

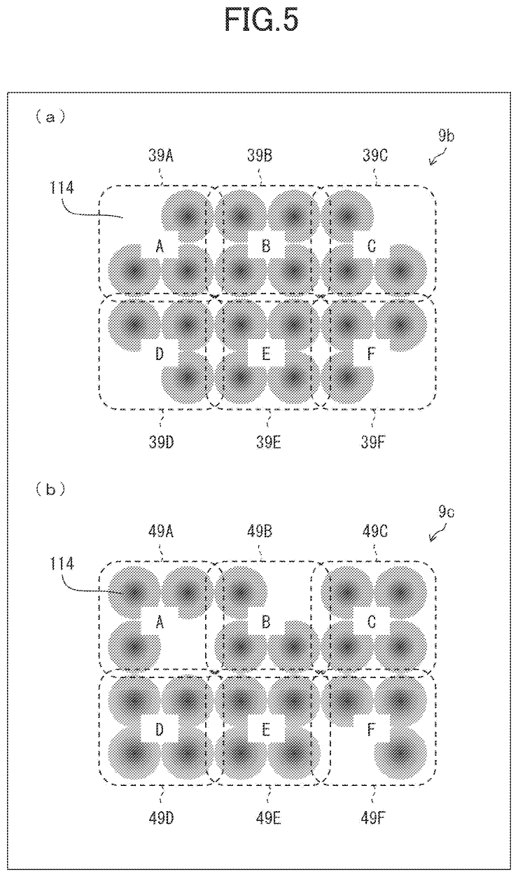

With reference to FIGS. 4 and 5, the following describes a second embodiment of the present invention. A display device according to this embodiment is different from the display device according to the first embodiment in that backlights 9, 9b, and 9c include a plurality of drive areas A, B, C, D, E, F . . . including two drive areas having different numbers of light-emitting elements 114 from each other. The other configuration is similar to that described in the first embodiment. For convenience in description, components having the same functions as those illustrated in the drawings relating to the first embodiment will be denoted by the same signs and will not be elaborated upon.

FIG. 4 illustrates part of the backlight 9a includable in the display device according to the second embodiment and being a target for area-active drive.

The entire backlight 9a is divided into a plurality of drive areas A, B, C, D . . . , each of which includes a plurality of light-emitting elements 114, as illustrated in FIG. 4. To be specific, the drive area A has a group of light-emitting elements 29A including four light-emitting elements 114, the drive area B has a group of light-emitting elements 29B including six light-emitting elements 114, the drive area C has a group of light-emitting elements 29C including four light-emitting elements 114, and the drive area D has a group of light-emitting elements 29D including ten light-emitting elements 114.

The drive areas A, B, C, and D are different from each other in shape, as illustrated in the drawing. The drive areas A, B, C, D . . . include four drive areas having different numbers of light-emitting elements 114 from each other.

The shapes of the individual drive areas A, B, C, D . . . and the number of light-emitting elements 114 included in the individual drive areas A, B, C, D . . . are illustrated in FIG. 4 by way of example, and can be determined as appropriate.

FIG. 5(a) illustrates part of the backlight 9b includable in the display device according to the second embodiment and being a target for area-active drive. FIG. 5(b) illustrates part of the backlight 9c includable in the display device according to the second embodiment and being a target for area-active drive.

The entire backlight 9b is divided into a plurality of drive areas A, B, C, D, E, F . . . , each of which includes a plurality of light-emitting elements 114, as illustrated in FIG. 5(a). To be specific, the drive area A has a group of light-emitting elements 39A including three light-emitting elements 114, the drive area B has a group of light-emitting elements 39B including four light-emitting elements 114, the drive area C has a group of light-emitting elements 39C including three light-emitting elements 114, the drive area D has a group of light-emitting elements 39D including three light-emitting elements 114, the drive area E has a group of light-emitting elements 39E including four light-emitting elements 114, and the drive area F has a group of light-emitting elements 39F including three light-emitting elements 114. The drive areas A, C, D, and F each include a region having no light-emitting elements 114 (this region is also called a hollow).

For the drive areas with hollows and for the drive areas without hollows, one emission intensity can be calculated for each of the drive areas A, B, C, D, E, F . . . through the foregoing method described in the first embodiment.

The entire backlight 9c is divided into a plurality of drive areas A, B, C, D, E, F . . . , each of which includes a plurality of light-emitting elements 114, as illustrated in FIG. 5(b). To be specific, the drive area A has a group of light-emitting elements 49A including three light-emitting elements 114, the drive area B has a group of light-emitting elements 49B including three light-emitting elements 114, the drive area C has a group of light-emitting elements 49C including four light-emitting elements 114, the drive area D has a group of light-emitting elements 49D including four light-emitting elements 114, the drive area E has a group of light-emitting elements 49E including four light-emitting elements 114, and the drive area F has a group of light-emitting elements 49F including three light-emitting elements 114. The drive areas A, B, and F each include a region having no light-emitting elements 114 (this region is also called a hollow). As illustrated in FIG. 5(b), the light-emitting elements 114 of the backlight 9c are asymmetrically arranged in both the up-and-down and side-to-side directions of the drawing.

The display device having the backlights 9a, 9b, and 9c includes the second light-source emission-intensity calculating unit 5 that, as described in the first embodiment, calculates the second emission intensity of each light-emitting element 114. The display device calculates, from the second emission intensity of each light-emitting element 114, the brightness distribution of each pixel of the display panel 11. The display device also calculates the spread of light (brightness distribution) in each pixel of the display panel 11 by using a common point spread function (PSF) of one light-emitting element as shown in FIG. 2(d).

The drive areas A, B, C, D . . . can thus include four kinds of drive area having different numbers of light-emitting elements 114 from each other, like the backlight 9a in FIG. 4. In addition, like the backlights 9b and 9c in FIGS. 5(a) and (b), one or more of the drive areas A, B, C, D, E, F . . . can include a region (hollow) having no light-emitting elements 114. In addition, like the backlight 9c in FIG. 5(b), the light-emitting elements 114 may be asymmetrically arranged in the up-and-down or side-to-side direction of the drawing.

This embodiment has described, as an example asymmetrical arrangement of the light-emitting elements 114 included in the backlight, that the drive areas include a region (hollow) having no light-emitting elements 114, as illustrated in FIG. 5(b). As a matter of course, such an asymmetrical arrangement is possible when the drive areas do not include a region (hollow) having no light-emitting elements 114.

### Third Embodiment

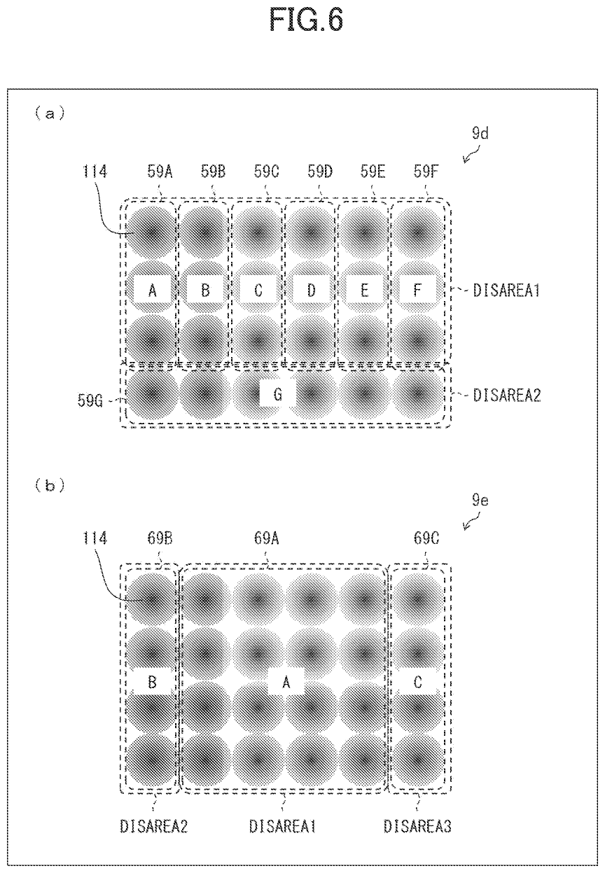

With reference to FIG. 6, the following describes a third embodiment of the present invention. The configuration of a display device according to this embodiment is similar to those of the display devices according to the first and second embodiments with the following exception: its display panel includes pixel regions corresponding to first regions DISAREA1 and provided for displaying a moving image, and includes pixel regions corresponding to second regions DISAREA2 and DISAREA3 and provided for displaying a still image. Herein, the first regions DISAREA1 are a part of a plurality of drive areas of backlights 9d and 9e, and the second regions DISAREA2 and DISAREA3 are another part of the drive areas. For convenience in description, components having the same functions as those illustrated in the drawings relating to the first and second embodiments will be denoted by the same signs and will not be elaborated upon.

FIG. 6(a) illustrates part of the backlight 9d includable in the display device according to the third embodiment and being a target for area-active drive. FIG. 6(b) illustrates part of the backlight 9e includable in the display device according to the third embodiment and being a target for area-active drive.

The entire backlight 9d is divided into a plurality of drive areas drives A, B, C, D, E, F, G . . . , each of which includes a plurality of light-emitting elements 114, as illustrated in FIG. 6(a). The drive areas A, B, C, D, E, F, G . . . respectively include groups of light-emitting elements 59A, 59B, 59C, 59D, 59E, 59F, 59G . . . each having a plurality of light-emitting elements 114. The groups of light-emitting elements 59A, 59B, 59C, 59D, 59E, 59F, 59G . . . are connected to respective different channels of a backlight drive circuit, not shown, and each constitute one unit of drive that is driven by the backlight drive circuit using a current value or PWM value.

The drive areas A, B, C, D, E, and F, a part of the drive areas A, B, C, D, E, F, G . . . of the backlight 9d, are the first region DISAREA1, which corresponds to a pixel region of the display panel where a moving image is to be displayed. The drive area G, another part of the drive areas A, B, C, D, E, F, G . . . of the backlight 9d, is the second region DISAREA2, which corresponds to a pixel region of the display panel where a still image is to be displayed. For instance, character information, a pictogram, and a symbol can be displayed in the pixel region of the display panel corresponding to the second region DISAREA2.

The above configuration enables the first region DISAREA1 for moving-image display and the second region DISAREA2 for still-image display to be controlled differently in conformance with what is to be displayed. For instance, the area-active driving unit 1 (shown in FIG. 1) may control the first region DISAREA1 to undergo area-active drive in accordance with a displayed moving image, and control the second region DISAREA2 not to undergo area-active drive.

The entire backlight 9e is divided into a plurality of drive areas drives A, B, C . . . , each of which includes a plurality of light-emitting elements 114, as illustrated in FIG. 6(b). The drive areas A, B, C . . . respectively include groups of light-emitting elements 69A, 69B, 69C . . . each having a plurality of light-emitting elements 114. The groups of light-emitting elements 69A, 69B, 69C . . . are connected to respective different channels of a backlight drive circuit, not shown, and each constitute one unit of drive that is driven by the backlight drive circuit using a current value or PWM value.

The drive area A, a part of the drive areas A, B, C . . . of the backlight 9e, is the first region DISAREA1, which corresponds to a pixel region of the display panel where a moving image is to be displayed. The drive areas B and C, another part of the drive areas A, B, C . . . of the backlight 9e, are the second regions DISAREA2 and DISAREA3, which correspond to pixel regions of the display panel where still images are to be displayed.

The above configuration enables the first region DISAREA1 for moving-image display and the second regions DISAREA2 and DISAREA3 for still-image display to be controlled differently in conformance with what is to be displayed. For instance, the area-active driving unit 1 (shown in FIG. 1) may cause the light-emitting elements 114 in the first region DISAREA1 to always remain lit on, and may cause the light-emitting elements 114 in the second regions DISAREA2 and DISAREA3 to remain lit on only when icons and other things are displayed in the second regions DISAREA2 and DISAREA3.

The display device having the backlights 9d and 9e includes the second light-source emission-intensity calculating unit 5 that, as described in the first embodiment, calculates the second emission intensity of each light-emitting element 114. The display device calculates, from the second emission intensity of each light-emitting element 114, the brightness distribution of each pixel of the display panel 11. The display device also calculates the spread of light (brightness distribution) in each pixel of the display panel 11 by using a common point spread function (PSF) of one light-emitting element as shown in FIG. 2(d).

This configuration enables the first region DISAREA1 and the second regions DISAREA2 and DISAREA3 to have any shape and any number of light-emitting elements 114.

The backlight 9e in FIG. 6(b) includes the drive areas A, B, and C, among which the drive areas B and C include four light-emitting elements 114 each. Instead of this configuration, the drive area B may be divided into four drive areas including one light-emitting element 114 each. The drive area C may be similarly divided into four drive areas including one light-emitting element 114 each. In this case, the backlight 9e includes nine drive areas, and the second regions DISAREA2 and DISAREA3 include eight drive areas. To display, for instance, icons in the second regions DISAREA2 and DISAREA3, only drive areas, among the eight drive areas, disposed in locations corresponding to the icons may be lit on.

Example Implementation by Software

Each unit included in the area-active driving unit 1 of the display device 12 may be implemented by a logic circuit (hardware) installed in, for instance, an integrated circuit (IC chip), or implemented by software.

For software, the display device 12 includes a computer that executes commands of a program, which is software that implements each function. The computer includes, for instance, at least one processor (controller) and at least one computer-readable recording medium storing the program. The processor in the computer reads the program from the recording medium and executes the program, thus achieving the object of the present disclosure. An example of the processor usable is a central processing unit (CPU). An example of the recording medium usable is a non-transitory tangible medium, including a read-only memory (ROM), a tape, a disc, a card, a semiconductor memory, and a programmable logic circuit. The computer may further include a random access memory (RAM) for developing the program. The program may be supplied to the computer via any transmission medium (e.g., a communication network and a broadcast wave) capable of transmitting the program. One aspect of the present disclosure can be implemented in the form of a data signal in which the program is embodied through electronic transmission and that is embedded in a carrier wave.

Additional Remarks

The present disclosure is not limited to the foregoing embodiments. Various modifications can be devised within the scope of the claims. In addition, an embodiment that is obtained in combination, as appropriate, with the technical means disclosed in the individual different embodiments is also included in the technical scope of the present disclosure. Furthermore, combining the technical means disclosed in the individual embodiments can provide a new technical feature.

### INDUSTRIAL APPLICABILITY

The present disclosure is applicable to a display device.

### REFERENCE SIGNS LIST

1 area-active driving unit (area-active drive circuit)
2 first emission-intensity calculating unit (first emission-intensity calculation circuit)
3 area-information storage
4 drive-area emission-intensity calculating unit (drive-area emission-intensity calculation circuit)
5 second emission-intensity calculating unit (second emission-intensity calculation circuit)
6 brightness-distribution calculating unit (brightness-distribution calculation circuit)
7 image-data correcting unit (image-data correction circuit)
8 backlight drive circuit
9, 9a, 9b, 9c, 9d, 9e backlight
10 panel drive circuit
11 display panel
12 display device
19A to 19F group of light-emitting elements
29A to 29D group of light-emitting elements
39A to 39F group of light-emitting elements
49A to 49F group of light-emitting elements
59A to 59G group of light-emitting elements
69A to 69C group of light-emitting elements
114 light-emitting element
A to G drive area
DISAREA1 first region
DISAREA2, 3 second region

1. A display device comprising:
an area-active drive circuit;
a backlight including a plurality of light-emitting elements that are controlled for each of a plurality of drive areas in accordance with a first signal from the area-active drive circuit; and
a display panel configured to perform display in accordance with a second signal from the area-active drive circuit,
wherein the area-active drive circuit includes
a first light-source emission-intensity calculation circuit configured to calculate a first emission intensity of each of the plurality of light-emitting elements in accordance with received image data,
a drive-area emission-intensity calculation circuit configured to calculate one emission intensity for each of the plurality of drive areas in accordance with the first emission intensity of each of the plurality of light-emitting elements and in accordance with area information about which of the plurality of drive areas each of the plurality of light-emitting elements belongs to, the drive-area emission-intensity calculation circuit being configured to output the one emission intensity as the first signal,
a second light-source emission-intensity calculation circuit configured to calculate a second emission intensity of each of the plurality of light-emitting elements in accordance with the one emission intensity in each of the plurality of drive areas, and
an image-data correction circuit configured to correct a gradation value of the received image data in accordance with a brightness distribution of a pixel of the display panel, the brightness distribution being calculated from the second emission intensity of each of the plurality of light-emitting elements, the image-data correction circuit being configured to output the gradation value after correction as the second signal.

2. The display device according to claim 1, wherein
the area-active drive circuit includes a brightness-distribution calculation circuit configured to calculate, from the second emission intensity of each of the plurality of light-emitting elements, the brightness distribution of the pixel of the display panel, and
the brightness-distribution calculation circuit uses a point spread function of one light-emitting element to calculate the brightness distribution.

3. The display device according to claim 1, wherein the area-active drive circuit includes an area-information storage storing the area information.

4. The display device according to claim 1, wherein
the one emission intensity calculated for each of the plurality of drive areas by the drive-area emission-intensity calculation circuit is a maximum value or average value of the first emission intensities of the plurality of light-emitting elements belonging to corresponding one of the plurality of drive areas.

5. The display device according to claim 1, wherein
the backlight is controlled by a backlight drive circuit in accordance with the first signal, and
the plurality of light-emitting elements are connected to different channels of the backlight drive circuit for each of the plurality of drive areas.

6. The display device according to claim 1, wherein the plurality of drive areas include a plurality of kinds of drive area different from each other in shape.

7. The display device according to claim 1, wherein the plurality of drive areas include a plurality of kinds of drive area having different numbers of the plurality of light-emitting elements from each other.

8. The display device according to claim 1, wherein one or more of the plurality of drive areas include a region not having the plurality of light-emitting elements.

9. The display device according to claim 6, wherein the plurality of light-emitting elements included in the backlight are asymmetrically arranged.

10. The display device according to claim 1, wherein
the display panel includes a pixel region corresponding to a first region and provided for displaying a moving image, the first region being a part of the plurality of drive areas, and
the display panel includes a pixel region corresponding to a second region and provided for displaying a still image, the second region being another part of the plurality of drive areas.
